(19) United States
(12) Patent Application Publication
(10) Pub. No.: US 2010/0230161 A1
(43) Pub. Date: Sep. 16, 2010

(54) Joint Structure Between a Wound Coil and An IC-Chip for a Noncontact RFID Device and Methods of Manufacturing The Same

(76) Inventor: Katsuji Hoshi, Hitachi-shi (JP)

Correspondence Address: WENDEROTH, LIND & PONACK, L.L.P., 1030 15th Street, N.W.,, Suite 400 East, Washington, DC, 20005-1503, US

(21) Appl. No.: 12/225,293

(22) PCT Filed: Mar. 28, 2007
(86) PCT No.: PCT/JP2007/056554

§ 371 Date: Sep. 18, 2008

(30) Foreign Application Priority Data
Apr. 6, 2006 (JP) 2006-105177

(51) Int. Cl. H01R 4/02; B23K 1/00; B23K 11/00; B23K 31/02; H01R 4/62

(52) U.S. Cl. 174/94 R; 228/101; 219/85.15; 228/265

(57) ABSTRACT

The present invention aims to provide such a joint structure of a wound coil 1 and an IC chip 2 for a noncontact RFID device that is able to yield electrically and mechanically excellent connection, employing the wound coil 1, which is made by winding copper electric wire, with small variance of the electric resistance as an antenna coil for the noncontact RFID device, also by making use of such IC chips that their joint terminals 3 are covered with such metallization of the gold outermost layer 3a that is not liable to degradation during storage; and aims to provide such a method of joining the wound coil 1 and the IC chip 2 for the noncontact RFID device that is able to make said joint structure with ease and certainty, through selecting a direct joining process low in production cost as the joining method of the two, also through improving the process.

### TECHNICAL FIELD

The present invention relates to a joint structure of a wound coil and an IC chip for a noncontact RFID device that joins the wound coil and the joint terminal of the IC chip for said noncontact RFID device, and that is used as a means of automatically identifying individuals of articles or persons in many different fields, such as service industries, selling businesses, manufacturing industries, physical-distribution industries, the financial sector, and also relates to a method of joining a wound coil and an IC chip for the noncontact RFID device in order to construct the joint structure.

### BACKGROUND ART

Recently, automatic identification of individuals [auto-id with a RFID] has come universally utilized so as to identify various articles/services handled or persons concerned in different industrial fields, such as various service industries, selling businesses, distribution industries, manufacturing industries, physical-distribution industries. Bar code labels have been widely used as a means of automatically identifying the individuals as mentioned above, however, IC cards, which have by far larger storage capacity and also re-programmability, are at present regarded as the prospective next and are gradually replacing the former.

There are a contact type and a noncontact type of said IC cards. Since the latter, the noncontact type of them requires no physical contact for supplying electric power to a data carrier device and in exchanging data between a card reader and the data carrier device, they considered to be of extremely high practical use due to perfect avoidance of a corrosion problem or a pollution problem on contact surfaces.

As regards said noncontact IC cards, it is desirable that the electric resistance of the antenna coils are made as small as possible in order to ensure the optimum electromagnetic inductive coupling between an antenna coil of the carrier device and a corresponding antenna of the card reader, and also to ensure the subsequent information exchange [supply of electric power]. From that point of view, silver, copper, gold and aluminum, in order of rising magnitude of electric resistance, may be more suitable than the next one for the material of the antenna coil, however, the present inventor consider that copper should be selected as the most practicable material in view of stability under operating environment and of its economy.

As for methods of manufacturing said antenna coil, there are a method of winding copper electric wire [patent documents 1,2 and 3], that of etching copper foil, that of printing with electrically conductive polymer ink, etc. Among those methods, the method of etching copper foil is superior in mass productivity and able to produce coils of low electric resistance, but there are such problems that variance of the electric resistance is too large and that the exhaust water yielded in the manufacturing process must be laboriously treated. The method of printing with said electrically conductive polymer ink is excellent in mass productivity as well as that of etching, however, is not practical because of high electric resistance of the coils obtained. Furthermore, antenna coils printed with ink using silver powder are poor at environmental stability and those using gold powder or gold fiber are poor at economical competitiveness. Mass productivity of the method of winding copper electric wire is not so good as that of the other two methods but variance of the electric resistance of the coils obtained are small enough for the present inventor to consider that said method is at present the best method of producing antenna coils for supplying stable and highly efficient noncontact IC cards.

On the other hand, joint terminals of an IC chip are composed of metallization in which plural metals are stacked in layers, and on the market are IC chips comprising joint terminals of Ti—W—Au where titanium, tungsten and gold are stacked in order from the innermost layer, joint terminal of Cr—Ni—Ag, joint terminals of Cr—Ni—Au, etc. The method of joining joint terminals to coils should be selected in consideration of the characteristics of the outermost layer metal such as gold, silver respectively, the present inventor considers that it is preferable to employ the metallization with the gold outermost layer because of less degradation during storage.

As method of joining the wound coils for noncontact IC cards, which are manufactured by said process of winding copper electric wire, to the above-mentioned joint terminals of the IC chips, are well-known an indirect process and a direct process. The indirect process in the present invention is a process of joining joint terminals to coils with the aid of interposers in between, and the direct process is that of joining coils and joint terminals by soldering or with electrically conductive adhesive.

Among the direct joining process described above, with regards to power supplies of the joining methods by soldering, those using a laser beam [patent documents 4] or an electric power supply for resistance welding are well-known, however, the joining processes by soldering are subjected to embrittlement of the joint due to alloying of solder with gold in the case that joint terminals may comprise metallization with the gold outermost layer and additionally are restrained on the operating temperature range because of the low melting point of the solder used. Besides, in the joining process by thermocompression bonding, the technology of stably forming a ball at the end of copper electric wire composing a coil is not established and therefore reliability of joint remains uncertain. Furthermore, in the joining process by ultrasonic welding frequently used for aluminum electric wire, there remains a problem that larger rigidity of copper wire composing a coil than that of aluminum is liable to cause damage to chips and joint terminals.

On the other hand, said indirect process has such a problem as increase in cost due to employment of interposers manufactured in a separate process between joint terminals and copper wire composing coils, increase in man-hour due to increase in cutting operations and the number of joining operations. Further, since interposers particularly require mass productivity, a printing process or an etching process described in the antenna coil manufacturing should be employed resulting in severe restraint on the operating conditions because of respective disadvantages inherent to each process.
Patent Document 1: Japanese Patent, 2005-184427A
Patent Document 2: Japanese Patent, 2003-303731A
Patent Document 3: Japanese Patent, 2002-352203A
Patent Document 4: Japanese Patent, 2001-047221A

### DISCLOSURE OF THE INVENTION

### Problem to be Solved by the Invention

The present invention aims to provide such a joint structure of a wound coil and an IC chip for a noncontact RFID device that is able to yield electrically and mechanically excellent connection, employing the wound coil, which is made by winding copper electric wire, with small variance of the electric resistance as an antenna coil for the noncontact RFID device, also by making use of such an IC chip that their joint terminals is covered with metallization of the gold outermost layer which is not liable to degradation during storage, and aims to provide such a method of joining the wound coil and the IC chip for the noncontact RFID device that is able to make said joint structure with ease and certainty, through selecting a direct joining process low in production cost as the joining method of the two, also through improving the process.

### Means for Solving Problem

The first embodiment of the present invention is a joint structure of a wound coil and an IC chip for a noncontact RFID device, being bonded through making a Au—Cu continuous solid solution form in the vicinity of an interface between the coil and the joint terminal of the chip by heating and pressing the two, wherein the coil is made of copper (Cu) and the outermost layer of said joint terminal is composed of gold (Au).

The second embodiment of the present invention is a method of joining a wound coil and an IC chip for a noncontact RFID device comprising the steps of providing a wound coil made of copper (Cu) and an joint terminal of the IC chip, the outermost layer of said joint terminal being composed of gold (Au); setting the coil on the joint terminal; pressing the coil to the joint terminal during heating the two; bonding directly the two through making a Au—Cu continuous solid solution form in the vicinity of an interface between both; and constructing the joint structure of the claim 1 between the wound coil and the IC chip for the noncontact RFID device.

The third embodiment of the present invention is the method of joining the wound coil and the IC chip for the noncontact RFID device according to claim 2, wherein the step of pressing during heating is performed by means of indirectly heated resistance welding.

The fourth embodiment of the present invention is the method of joining said wound coil and said IC chip for the noncontact RFID device according to claim 2 or 3, wherein the heating temperature and the pressing force in the step of pressing during heating are both empirically determined in order to make a Au/Cu continuous solid solution formed in the vicinity of an interface between the wound coil and the joint terminal of the IC chip.

The fifth embodiment of the present invention is the method of joining the wound coil and the IC chip for the noncontact RFID device according to claim 2 or 3, wherein the pressing force is defined in order to make the ratio t/D, of the thickness t of the corresponding part of wound coil after plastic deformation to the wire diameter D before the deformation, more than 0.1 and less than 0.8.

### Effect of the Invention

With regard to the joint structure of a wound coil and an IC chip for a noncontact RFID device according to the first embodiment of the present invention, the joining of the wound coil and the joint terminal of the IC chip is confined to that of making the Au—Cu continuous solid solution formed in the vicinity of the interface between the coil and the outermost gold-film layer of the joint terminal, and therefore both joining with high mechanical strength and electrically excellent connection are assured. Needless to say, the abovementioned problems usually observed in the joints made by soldering, etc. will never occur.

By means of the method of joining the wound coil and the IC chip for the noncontact RFID device according to the second embodiment of the present invention, the Au—Cu continuous solid solution may be formed easily and surely in the vicinity of the interface between the wound coil and the outermost gold-film layer of the joint terminal of the IC chip, and therefore the joint structure of the wound coil and the IC chip for the noncontact RFID device according to the first embodiment of the present invention can be made in proper condition at low cost.

By means of the method of joining the wound coil and the. IC chip for a noncontact RFID device according to the third embodiment of the present invention, the step of pressing during heating is confined to indirectly heated resistance welding and therefore the wound coil mounted on the joint terminal of the IC chip is easily supplied with necessary heat quantity and pressing force through suitably forming an electrode with highly electrically resistant refractory metal, and through energizing the electrode with electric current on a practical level to reach a desired high temperature.

By means of the method of joining said wound coil and said IC chip for the noncontact RFID device according to the fourth embodiment of the present invention, the temperature and the pressing force to be applied to the wound coil mounted on the joint terminal of the IC chip may be set easily and suitably.

By means of the method of joining the wound coil and the IC chip for the noncontact RFID device according to the fifth embodiment of the present invention, stable bonding strength of the joint may be obtained between the joint terminal of the IC chip and the wound coil.

### DESCRIPTION OF THE PREFERRED EMBODIMENT

The present invention, as shown in FIG. 3 and FIG. 4, provides such a joint structure of a wound coil 1 and a joint terminal 3 of an IC chip 2 for a noncontact RFID device that is joined via a Au—Cu continuous solid solution alloy layer 5 formed by heating and pressing in the vicinity of the interface between the wound coil made of copper and the joint terminal of the IC chip, the outermost layer of which is made of a Au film (gold film) 3a, and as shown in FIG. 1, further provides such a method of joining the wound coil and the IC chip for the noncontact RFID device that said joint structure is made by directly joining the wound coil 1 made of copper to the joint terminal 3, the outermost layer of which is made of a Au film 3a, of the IC chip 2.

Besides, as shown in FIG. 1, the joining defined in said method of joining is performed by the steps of first putting the wound coil 1 on the joint terminal 3, then pressing the former down during heating to make the Au—Cu continuous solid solution alloy layer 5 form in the vicinity of the interface between the two, finally establishing the sound connection between the wound coil 1 and the joint terminal 3 through constructing said joint structure.

Said noncontact RFID device is defined in the present invention as card type or tag type RFID devices, which internally contain IC chips including microprocessors etc., and where transfer of electric power or exchange of information between said IC chips and an external reader/writer is performed via said wound coil.

Said wound coil 1 is manufactured from electric wire made of copper as mentioned before and copper core wire 1b of the copper electric wire is coated with insulator film la. Therefore, said copper electric wire is defined, of course, as the electric wire, the copper core wire 1b of which is made substantially of copper. Consequently, the copper electric wire comprising copper core wire 1b containing so small impurities as to change electric conductivity of pure copper by ±10% or less is obviously included in this category whether the impurities are added intentionally or not. Besides, said insulator film 1a may consist of various thermoplastic resins.

As mentioned before, the outermost layer of said joint terminal 3 of the IC chip 2 should comprise a gold film 3a but the metal for an intermediate layer 3b and the innermost layer 3c is not restricted to the specific element. As well-known in the art, the material for the innermost layer 3c is selected for the purpose of ensuring ohmic contact between the chip 2 and itself, and one for the intermediate layer 3b is selected, as a general rule, for the purpose of preventing mutual diffusion between the gold film 3a and the innermost layer 3c. For the metallization composing such kind of joint terminals 3, as described above, metallizations stacked and coated from the innermost layer to the outermost layer in order of Ti—W—Au, in order of Cr—Ni—Ag, in order of CrNi—Au, etc. are supplied on the market. Among these metallizations, those stacked and coated in order of Ti—W—Au or Cr—Ni—Au may be employed.

Besides, 24 karat gold is usually employed as the gold (Au) of the outermost layer and its purity is beyond 99.99%. However, gold in the present invention is not restricted to such a highly pure one but signifies the whole that may be called substantially as gold in the art.

Said step of pressing during heating is performed, as shown in FIG. 1, through putting the prescribed portion of the wound coil 1 on the joint terminal 3, then pressing the former down, and any processes may be employed without limitation if only the process can make the Au—Cu continuous solid solution alloy layer 5 form in the vicinity of the interface between the two, as shown in FIG. 3 and FIG. 4.

For example, as shown in FIG. 1, indirectly heated resistance welding may be employed as said means and such a method may also be employed that heat is generated at an electrode 4 by energizing the electrode as the arrow al shows; then said heat is transferred from said electrode 4 via a wound coil 1 to a joint terminal 3 as the arrow a2 shows; finally said wound coil 1 is pressed down by said electrode 4 while said heat is transferring as the arrow a3 shows. When the indirectly heated resistance welding is employed, the wound coil 1 mounted on the joint terminal 3 of the IC chip 2 may be supplied with necessary heat quantity and pressing force through suitably shaping the electrode 4 with highly electrically resistant refractory metal such as tungsten (W), molybdenum (Mo) and through reaching a desired high temperature with electric current on a practical level.

Besides, as mentioned before, even though said wound coil 1 is generally manufactured from copper electric wire the copper core wire 1b of which is coated with insulator film la, said insulator film 1a may be melt down by heating with said electrode 4 in the preceding process to be expelled from an interface between the gold film of the joint terminal 3 and the copper core wire 1b resulting in formation of the Au/Cu continuous solid solution alloy layer 5 in the vicinity of said interface.

On the other hand, employment of direct heating parallel-gap resistance welding is not suitable to such kind of heating and pressing step as above. The reasons are because such a laborious operation as to remove beforehand the insulator film 1a from the prescribed portion of the wound coil 1 is necessary for ensuring electrical contact; and because sufficient heat quantity cannot be generated, by supplying electric current only on practical level, at a contact area between the copper core wire 1b of the wound coil and the joint terminal 3 on which the former is mounted, due to extremely small electric resistance of the contact area between the two. Further, since one of the two electrodes should be butted against the copper core wire 1b of the wound coil 1 and the other should obviously be contacted to the joint terminal 3, it is necessary to provide the contact area within the joint terminal 3 resulting in the enlargement of the joint terminal 3. According to the reasons above, direct heating parallel-gap resistance welding is not considered to be practicable for such a case as above.

Additionally, from the viewpoint of a preferred range of the butted area of the prescribed portion of the copper wound coil 1 against the joint terminal, said “the vicinity of the interface” in which said Au—Cu continuous solid solution alloy layer 5 may be formed is preferably at least half of the whole contact area; more preferably as large as possible. From the viewpoint of a preferred range of thickness of said butted interface, the thickness is preferably as thick as several atoms to scores of atoms from said butted interface, and practically sufficient bonding strength can be obtained when said Au—Cu continuous solid solution alloy layer 5 is formed as thick as that within the preferred range.

A heating temperature and a pressing force in the step of pressing during heating are empirically determined in order to make a Au—Cu continuous solid solution alloy layer 5 form in the vicinity of a mutual interface between the wound coil 1 and the joint terminal 3 of the IC chip 2. More concretely, said heating temperature should be defined as such a temperature as to make the copper core wire 1b of said pressed wound coil 1 plastically flow relative to the gold film 3a when said heating and pressing means including the electrode 4 of the indirectly heated resistance welding is butted against the wound coil 1 on the joint terminal 3, and also when the generated heat is transferring through said wound coil 1→the contact interface→the gold film 3a; said heating temperature should be also defined as such a temperature as to make the insulator film 1a melt down resulting in direct contact of gold and copper atoms at the interface between the Au film 3a and the copper core wire 1b. On the other hand, said heating temperature should be also defined as such a temperature as not to oxidize the surface of the copper core wire 1b or not to cause any damage to the IC chip 2. Besides, said pressing force should be defined so as to cause sufficient plastic flow and not so as to cause any damage to the IC chip 2.

Said heating temperature should be controlled according to the preceding description. When indirectly heated resistance welding is employed as mentioned above, such a way of determination is appropriate that first, generated heat quantity is controlled in a bonding test by controlling the supplying electric current and the weld time; secondly, more preferable electric current and weld time are determined according to the results obtained in the bonding test. The control of the electric current as mentioned above is usually performed through controlling electric voltage. Therefore, the control of a heating temperature will be mostly performed through controlling electric voltage and impressed time respectively at the electric voltage and the impressed time corresponding with the proper heating temperature.

It is widely known in the art that the ratio of thickness t after plastic deformation of the electric wire to its original diameter D is an important parameter affecting the reliability of joints. The parameter is particularly important for the joining method of the present invention in which joining is performed at a temperature significantly lower than the melting points of the Au film 3a and copper core wire 1b. Though it depends on a kind of material, a combination of materials, and properties of material, stable bonding strength is obtained for the combination of the joint terminal 3, the outermost layer of which is Au film 3a, and the copper wound coil of the present invention, as shown in FIG. 5, in a wide range between more than or equal to 0.1 and less than or equal to 0.8 of t/D (the ratio of thickness t after plastic deformation of the electric wire to its original diameter D).

Said pressing force should be confined so as to make t/D fall in said range of plastic deformation in order to assist/promote the mutual diffusion of gold and copper atoms by plastic deformation in the vicinity of the interface at a relatively low temperature (an interfacial temperature is assumed to be 500° C. from the experiment) lower than individual melting point. Since the fraction defective of IC chips is liable to increase slightly as t/D approaches 0.1 due to stress undergone on the IC chip 2 via the joint terminal 3, it is preferable not to allow t/D to approach too near 0.1.

Consequently, mechanical connection with high bonding strength as well as electrically excellent connection may be assured at low cost, according to the joint structure of a wound coil and an IC chip for a noncontact RFID device and the method of joining a wound coil and an IC chip for a noncontact RFID device of the present invention, through making a Au—Cu continuous solid solution alloy layer 5 form in the vicinity of the interface between copper core wire 1b of the wound coil 1 and the outermost gold-film layer 3a of the joint terminal 3 of the IC chip. More concretely speaking, since the melting point of the joined portion between the wound coil 1 and the joint terminal 3 of the IC chip 2 is beyond 1000° C. because of the formation of the Au—Cu continuous solid solution alloy layer 5, the reliability of the joined portion will be remarkably high due to cancellation of the problems that are disadvantages of said joints formed via soldering such as a low applicable temperature range, formation of brittle compound layers.

### Example 1

As shown in FIG. 1, employing a wound coil 1 made of copper electric wire the copper core wire of which is coated with insulator film la, putting the prescribed portion of the wound coil 1 on the outermost Au film 3a of a joint terminal 3 of an IC chip 2, then making an electrode 4 abutted against the wound coil 1 below, pressed down the electrode 4 during generating heat by energizing said electrode.

### Articles to be Joined

Diameter of the wound coil: Φ70 μm±3 μm (insulator film 1a: polyurethane coating)
IC chip 2: □1000 μm, Ti—W—Au metallization of joint terminal 3 (thickness of Au film: 10 μm)

### Heating/Pressing Means

Electrode 4: W (tungsten), for indirectly heated resistance welding

### Welding Parameters

Welding voltage: 1.8 V
Resistance welding time: 0.5 seconds
Pressing force: 80 grams

As shown in Table 1 below, the joints between the joint terminal 3 of the IC chips 2 and the wound coil 1 yield sufficiently strong bonding strength superior to those joined by conventional soldering, thermo-compression bonding, and ultrasonic bonding, respectively, and also yield extremely low fraction defective, which thereby proves the effectiveness of the present invention.

TABLE 1

| | Results of the measurement | | | |
|---|---|---|---|---|
| | | | Thermo- | |
| | | | compression | Ultrasonic |
| Parameters | Example 1 | Soldering | bonding | bonding |
| Chip | 0/1000 | 0/1000 | 2/1000 | 7/1000 |
| fraction defective | | | | |
| Bonding | 40-65 | 20-35 | 31-45 | 20-64 |
| strength (N) | | | | |
| Temperature cycle | 0/1000 | 2/1000 | 0/998 | 0/997 |
| fraction defective | | | | |

The results of the experiment for soldering, thermo-compression bonding, ultrasonic bonding, as shown in Table 1, are for the joints obtained by respective standard joining operations.

Method of Measuring Bonding Strength shown in Table 1 and the following Table 2

A coil was pulled perpendicular to a surface of a joint terminal at room temperature under the condition where an IC chip was fixed on a jig base by means of a digital tension gauge whose sensitivity is 1 N. Readings of the gauge when joined portions were torn off or coils were broken are adopted as the bonding strength for that joint.

Method of Temperature Cycle Test shown in Table 1 and the following Table 2

RFID devices were set in a temperature cycle tester and the temperature cycle test between −55° C. and 150° C. were repeated once per 2 hours for 100 cycles. After the test was finished the acceptance or rejection of the RFID devices were decided through measuring their communication characteristics. The number of such rejected devices that the cause of defects was proved to be failure at the joints, are adopted as the number of the defectives.

### Example 2

Employing a wound coil 1 made of copper electric wire, the copper core wire of which is coated with insulator film 1a, joining the prescribed portion of the wound coil 1 a joint terminal 3 of an IC chip 2 was performed through the similar operations in Example 1.

### Articles to be Joined

Diameter of the wound coil: Φ60 μm±3 μm (insulator film 1a: polyurethane coating)
IC chip 2: □900 μm, Cr—N—Au metallization of joint terminal 3 (thickness of Au film 3a: 10 μm)

### Heating/Pressing Means

Electrode 4: Mo (molybdenum), for indirectly heated resistance welding

### Welding Parameters

Welding voltage: 1.1 V
Resistance welding time: 0.9 seconds
Welding force: 70 grams

As shown in Table 2 below, the joints between the joint terminal 3 of the IC chips 2 and the wound coil 1 yielded sufficient bonding strength similar to those in Example 1, and also yielded extremely low fraction defective in the temperature cycle test, which thereby proves the effectiveness of the present invention.

TABLE 2

Results of
the measurement

| | | Interposer- |
|---|---|---|
| | | aided |
| Parameters | Example 2 | bonding |
| Chip | 0/10000 | 0/1000 |
| fraction defective | | |
| Bonding | 32-54 | 45-50 |
| strength (N) | | |
| Temperature cycle | 0/10000 | 38/1000 |
| fraction defective | | |

With regard to the joints welded by interposer-aided bonding shown in Table 2, the joint terminal of the IC chip and the wound coil are joined via a tin-plated copper lead-frame in between, wherein the joint terminal of the IC chip and one end of the lead-frame are glued together with electrically conductive adhesive, and otherwise the wound coil and the other end of the lead-frame are soldered. The soldering in this example was carried out through a well-known standard operation. The results of the measurement listed in the column of interposer-aided bonding in Table 2 are obtained for the joints made through above-mentioned steps.

### BRIEF DESCRIPTION OF THE DRAWINGS

FIG. 1 is a cross section illustrating an embodiment of the present invention;

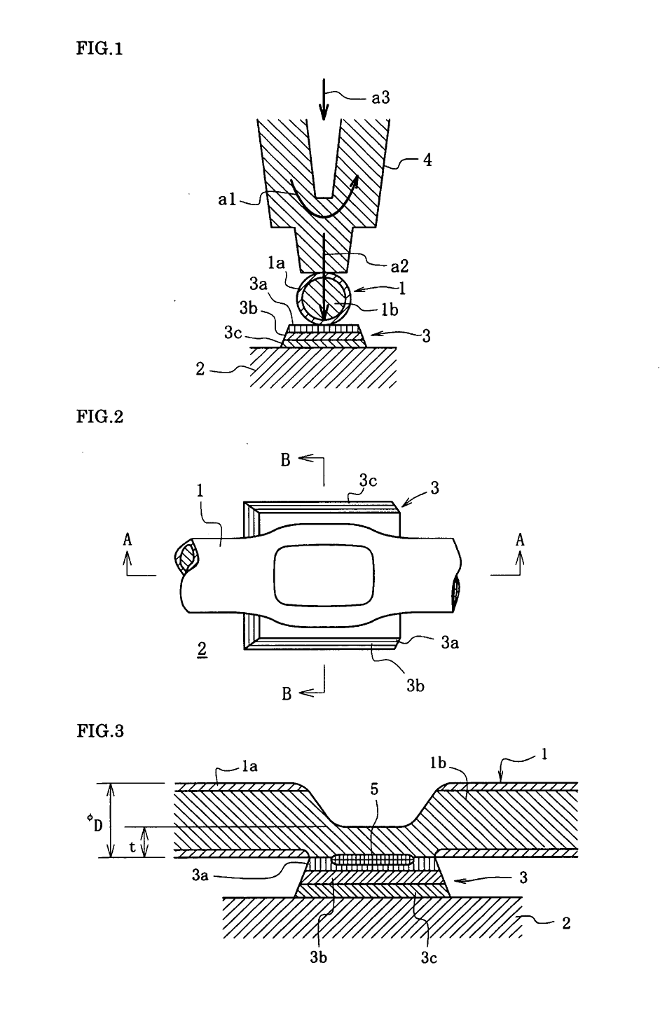

FIG. 2 is a schematic perspective plain view illustrating a joint obtained through putting the present invention into practice;

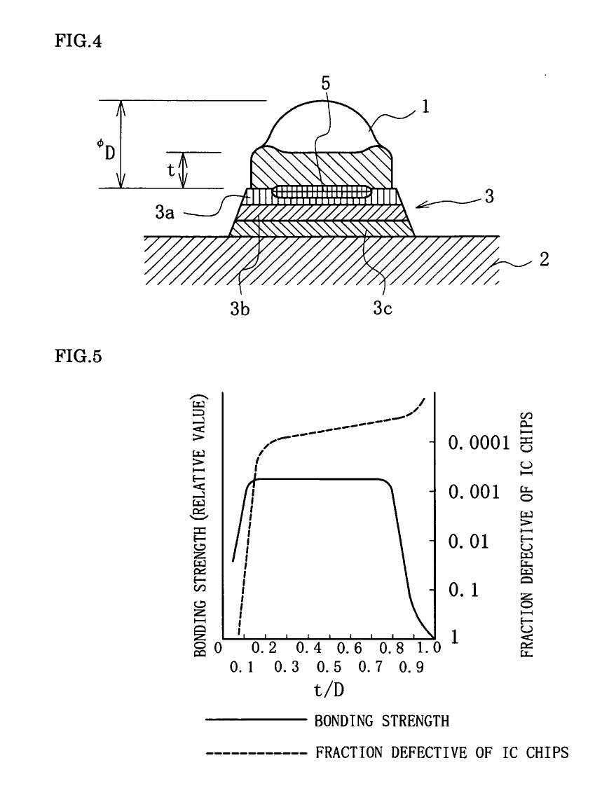

FIG. 3 is a schematic cross section illustrating the A-A section in FIG. 2;

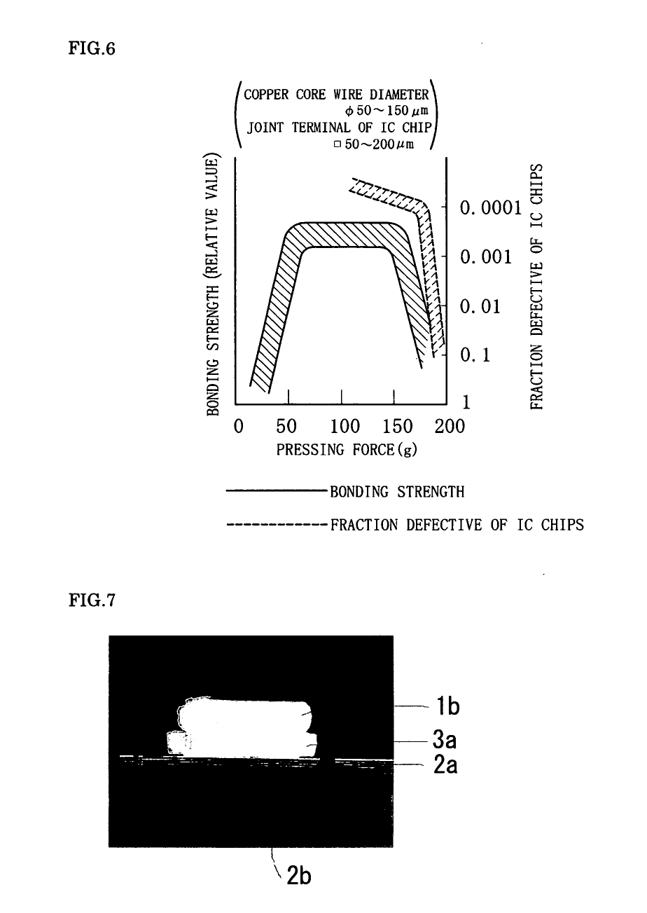

FIG. 4 is a schematic cross section illustrating the B-B section in FIG. 2; and

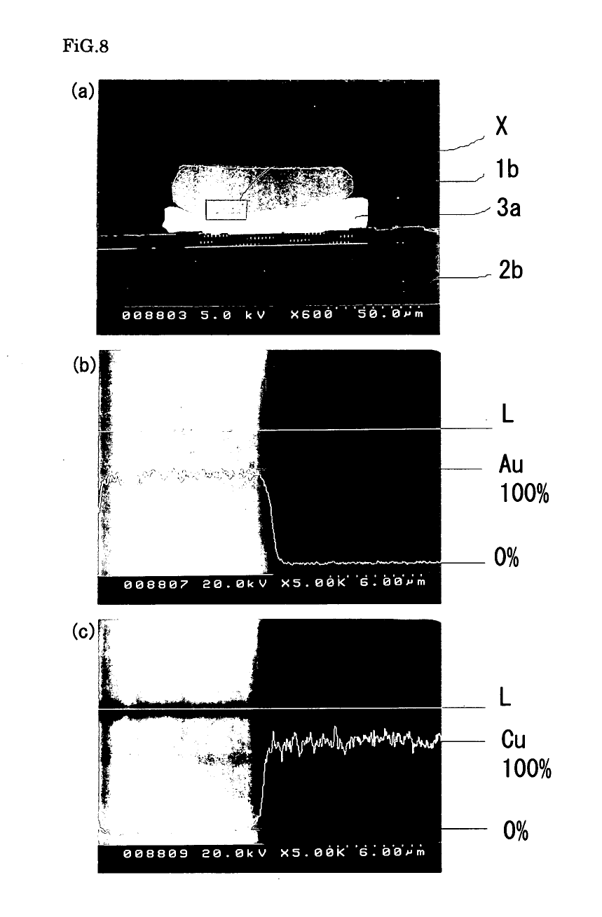

FIG. 5 is a diagram illustrating the relation ship among bonding strengths of joints, fraction defectives of chips, and t/D.

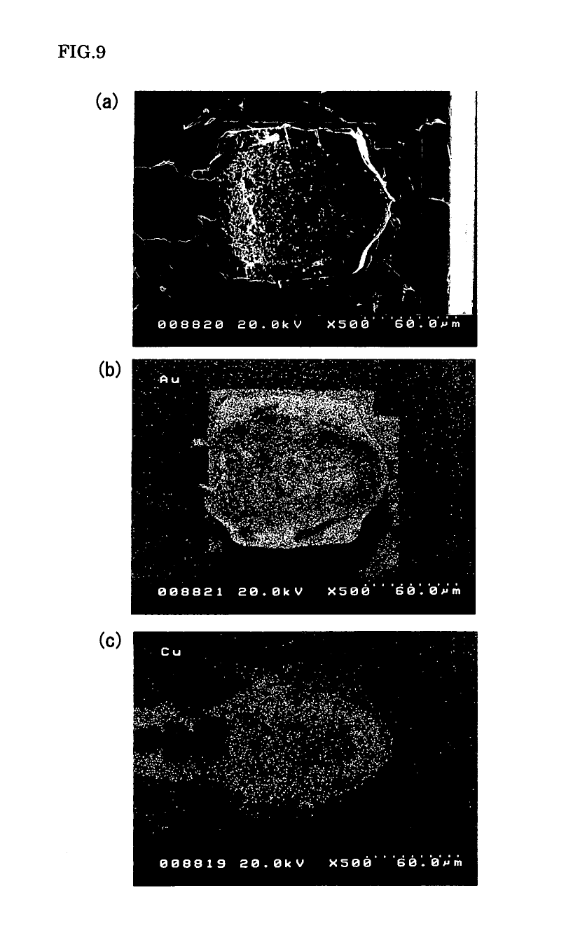

### EXPLANATIONS OF LETTERS OR NUMERALS

1 wound coil
1a insulator film
1b copper core wire
2 IC chip
3 joint terminal
3a Au film (gold film)
3b intermediate layer
3c innermost layer
4 electrode
5 alloy layer consisting of Au/Cu continuous solid solution
a1 arrow showing the direction of flow of electric current
a2 arrow showing the direction of heat transfer
a3 arrow showing the direction of pressing

1. A joint structure of a wound coil and an IC chip for a noncontct RFID device, being bonded through making a Au/Cu continuous solid solution form in the vicinity of an interface between the coil and a joint terminal of the IC chip by heating and pressing the two, wherein said coil is made of copper (Cu) and the outermost layer of said joint terminal is composed of gold (Au).

2. A method of joining a wound coil and an IC chip for a noncontact RFID device comprising the steps of:
providing a wound coil made of copper (Cu) and an joint terminal of the IC chip, the outermost layer of said joint terminal being composed of gold (Au);
setting said coil on said joint terminal;
pressing said coil to said joint terminal during heating the both;
bonding directly the two through making a Au/Cu continuous solid solution formed in the vicinity of an interface between the both; and
constructing the joint structure of the claim 1 between said wound coil and said IC chip for the noncontact RFID device.

3. The method of joining said wound coil and said IC chip for a noncontact RFID device according to claim 2, wherein the step of pressing during heating is performed by means of indirectly heated resistance welding.

4. The method of joining said wound coil and said IC chip for a noncontact RFID device according to claim 2, wherein the heating temperature and the pressing force in the step of pressing during heating are both empirically determined in order to make a Au/Cu continuous solid solution formed in the vicinity of an interface between said wound coil and the joint terminal of said IC chip.

5. The method of joining said wound coil and said IC chip for a noncontact RFID device according to claim 2, wherein said pressing force is defined in order to make the ratio t/D of the thickness t of the corresponding part of wound coil after plastic deformation to the wire diameter D before the deformation more than 0.1 and less than 0.8.

6. The method of joining said wound coil and said IC chip for a noncontact RFID device according to claim3, wherein the heating temperature and the pressing force in the step of pressing during heating are both empirically determined in order to make a Au/Cu continuous solid solution formed in the vicinity of an interface between said wound coil and the joint terminal of said IC chip.

7. The method of joining said wound coil and said IC chip for a noncontact RFID device according to claim 3, wherein said pressing force is defined in order to make the ratio t/D of the thickness t of the corresponding part of wound coil after plastic deformation to the wire diameter D before the deformation more than 0.1 and less than 0.8.
